(19) United States
(12) Patent Application Publication
(10) Pub. No.: US 2026/0025299 A1
(43) Pub. Date: Jan. 22, 2026

(54) APPARATUS AND METHOD FOR PERFORMING TRAINING FOR TRANSCEIVER MODEL IN WIRELESS COMMUNICATION SYSTEM

(71) Applicant: LG ELECTRONICS INC., Seoul (KR)

(72) Inventors: Kyungho LEE, Seoul (KR); Bonghoe KIM, Seoul (KR); Sangrim LEE, Seoul (KR); Yeongjun KIM, Seoul (KR)

(73) Assignee: LG ELECTRONICS INC., Seoul (KR)

(21) Appl. No.: 18/996,299

(22) PCT Filed: Jul. 18, 2022
(86) PCT No.: PCT/KR2022/010439

§ 371 Date: Jan. 17, 2025

(51) Int. Cl. H04L 27/26; H04L 41/16

(52) U.S. Cl. CPC H04L 27/261; H04L 41/16

(57) ABSTRACT

The purpose of the present disclosure is to perform training for a transceiver model in a wireless communication system, and an operation method for user equipment (UE) may comprise the steps of: transmitting capability information to a base station; receiving, from the base station, configuration information related to reference signals; receiving the reference signals on the basis of the configuration information; and transmitting feedback information corresponding to the reference signals. The feedback information may include information related to at least one preferred reference signal pattern selected by the UE, and may request to transmit reference signals according to the preferred reference signal pattern.

### CROSS-REFERENCE TO RELATED APPLICATION

This application is the National Stage filing under 35 U.S.C. 371 of International Application No. PCT/KR2022/010439, filed on Jul. 18, 2022, the contents of which is

### TECHNICAL FIELD

The present disclosure relates to a wireless communication system, and more particularly, to an apparatus and method for performing learning for a transceiver model in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (mMTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide an apparatus and method for effectively performing learning for a transceiver model in a wireless communication system.

The present disclosure may provide an apparatus and method for performing active learning for a transceiver model in a wireless communication system.

The present disclosure may provide an apparatus and method for determining a reference signal pattern for performing active learning for a transceiver model in a wireless communication system.

The present disclosure may provide an apparatus and method for generating information for determining a reference signal pattern necessary for active learning in a wireless communication system.

The present disclosure may provide an apparatus and method for exchanging necessary information for active learning for a transceiver model in a wireless communication system.

The present disclosure may provide an apparatus and method for determining uncertainty or diversity for a reference signal pattern in a wireless communication system.

The present disclosure may provide an apparatus and method for determining an acquisition function necessary to determine uncertainty or diversity in a wireless communication system.

The present disclosure may provide an apparatus and method for sharing prior distribution information of a transceiver model that is necessary to determine uncertainty or diversity in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method for operating a user equipment (UE) in a wireless communication system may include transmitting capability information to a base station, receiving configuration information related to reference signals from the base station, receiving the reference signals based on the configuration information, and transmitting feedback information corresponding to the reference signals. The feedback information may include information related to at least one preferred reference signal pattern selected by the UE and request to transmit reference signals according to the preferred reference signal pattern.

As an example of the present disclosure, a method for operating a base station in a wireless communication system may include receiving capability information from a user equipment (UE), transmitting configuration information related to reference signals, transmitting the reference signals based on the configuration information, and receiving feedback information corresponding to the reference signals from the UE. The feedback information may include information related to at least one preferred reference signal pattern selected by the UE and request to transmit reference signals according to the preferred reference signal pattern.

As an example of the present disclosure, a user equipment (UE) in a wireless communication system may include a transceiver and a processor coupled with the transceiver. The processor may be configured to transmit capability information to a base station, to receive configuration information related to reference signals from the base station, to receive the reference signals based on the configuration information, and to transmit feedback information corresponding to the reference signals. The feedback information may include information related to at least one preferred reference signal pattern selected by the UE and request to transmit reference signals according to the preferred reference signal pattern.

As an example of the present disclosure, a base station in a wireless communication system may include a transceiver and a processor coupled with the transceiver. The processor may be configured to receive capability information from a user equipment (UE), to transmit configuration information related to reference signals, to transmit the reference signals based on the configuration information, and to receive feedback information corresponding to the reference signals from the UE. The feedback information may include information related to at least one preferred reference signal pattern selected by the UE and request to transmit reference signals according to the preferred reference signal pattern.

As an example of the present disclosure, a communication device may include at least one processor and at least one computer memory coupled with the at least one processor and storing an instruction that instructs operations when executed by the at least one processor. The operations may include transmitting capability information to a base station, receiving configuration information related to reference signals from the base station, receiving the reference signals based on the configuration information, and transmitting feedback information corresponding to the reference signals. The feedback information may include information related to at least one preferred reference signal pattern selected by the communication device and request to transmit reference signals according to the preferred reference signal pattern.

As an example of the present disclosure, a non-transitory computer-readable medium storing at least one instruction may include the at least one instruction that is executable by a processor. The at least one instruction may control a device to transmit capability information to a base station, to receive configuration information related to reference signals from the base station, to receive the reference signals based on the configuration information, and to transmit feedback information corresponding to the reference signals. The feedback information may include information related to at least one preferred reference signal pattern selected by the device.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

As is apparent from the above description, the embodiments of the present disclosure have the following effects.

According to the present disclosure, a transceiver model may be effectively learned.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of artificial intelligence (AI) device applicable to the present disclosure.

FIG. 7 illustrates a method of processing a transmitted signal applicable to the present disclosure.

FIG. 8 illustrates an example of a communication structure providable in a 6th generation (6G) system applicable to the present disclosure.

FIG. 9 illustrates an electromagnetic spectrum applicable to the present disclosure.

FIG. 10 illustrates a THz communication method applicable to the present disclosure.

FIG. 11 illustrates a perceptron architecture in an artificial neural network applicable to the present disclosure.

FIG. 12 illustrates an artificial neural network architecture applicable to the present disclosure.

FIG. 13 illustrates a deep neural network applicable to the present disclosure.

FIG. 14 illustrates a convolutional neural network applicable to the present disclosure.

FIG. 15 illustrates a filter operation of a convolutional neural network applicable to the present disclosure.

FIG. 16 illustrates a neural network architecture with a recurrent loop applicable to the present disclosure.

FIG. 17 illustrates an operational structure of a recurrent neural network applicable to the present disclosure.

FIG. 18 illustrates sampling methods for active learning according to an embodiment of the present disclosure.

FIG. 19A to FIG. 19C illustrate examples of results of active learning and passive learning according to an embodiment of the present disclosure.

FIG. 20 illustrates functional structures of devices supporting active learning according to an embodiment of the present disclosure.

FIG. 21 illustrates an example of state transition by active learning according to an embodiment of the present disclosure.

FIG. 22 illustrates an example of operation timing of active reference signal transmission and channel estimation according to an embodiment of the present disclosure.

FIG. 23 illustrates an example of clustering according to an embodiment of the present disclosure.

FIG. 24 illustrates an example of a procedure of performing learning for a transmitter model or a receiver model according to an embodiment of the present disclosure.

FIG. 25 illustrates an example of a procedure of supporting learning for a transmitter model or a receiver model according to an embodiment of the present disclosure.

FIG. 26 illustrates an example of a procedure of providing capability information for active learning according to an embodiment of the present disclosure.

FIG. 27 illustrates an example of a procedure of performing active learning according to an embodiment of the present disclosure.

FIG. 28 illustrates examples of reference signal patterns for active learning according to an embodiment of the present disclosure.

FIG. 29A to FIG. 29C illustrate an example of uncertainty change according to uncertainty sampling-based active learning according to an embodiment of the present disclosure.

FIG. 30A and FIG. 30B illustrate an example of pattern selection for diversity sampling-based active learning according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc, may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.XXX Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc, used in the present disclosure, refer to matters described in the standard documents published prior to the present disclosure. For example, reference may be made to the standard documents 36.xxx and 38. XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

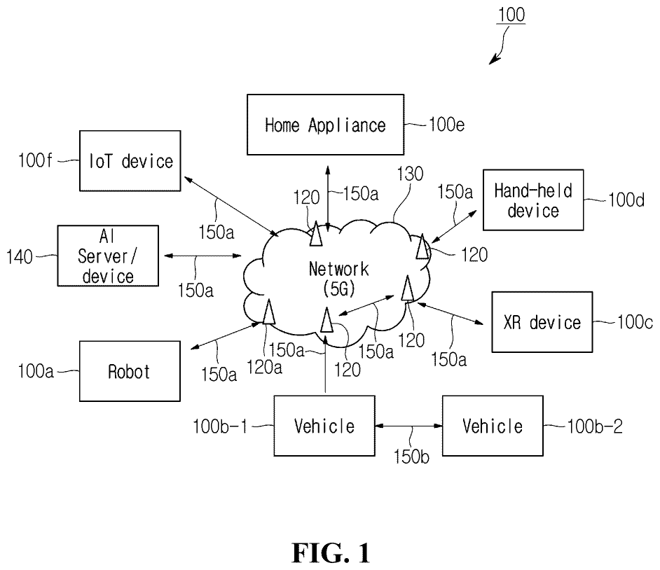

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2. an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a. 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc, may be performed.

### Communication System Applicable to the Present Disclosure

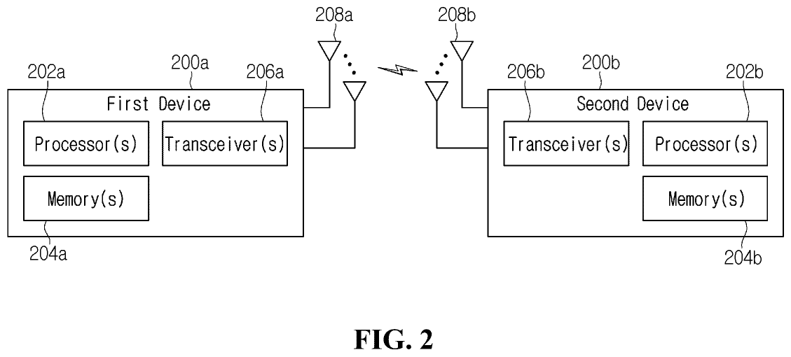

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions. functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b.

In addition, one or more memories 204a and 204b may be coupled with one or more processors 202a and 202b through various technologies such as wired or wireless connection,

One or more transceivers 206a and 206b may transmit user data, control information, radio signals/channels, etc, described in the methods and/or operational flowcharts of the present disclosure to one or more other apparatuses. One or more transceivers 206a and 206b may receive user data, control information, radio signals/channels, etc, described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc, described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc, from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

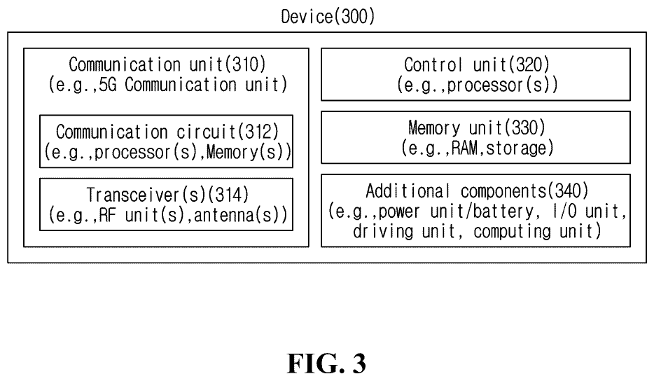

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

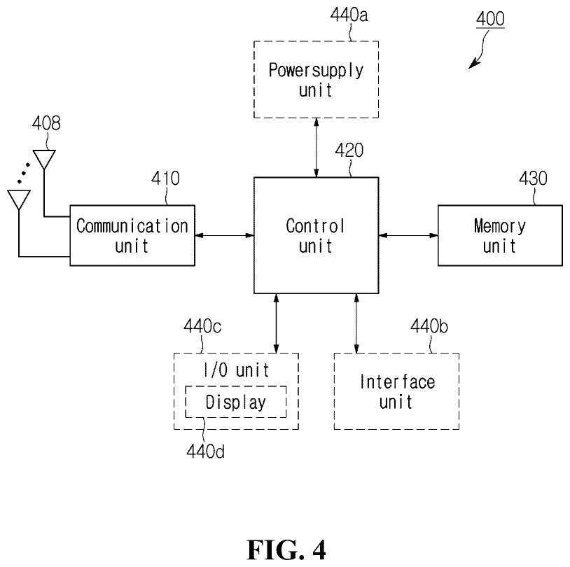

FIG. 4 illustrates an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

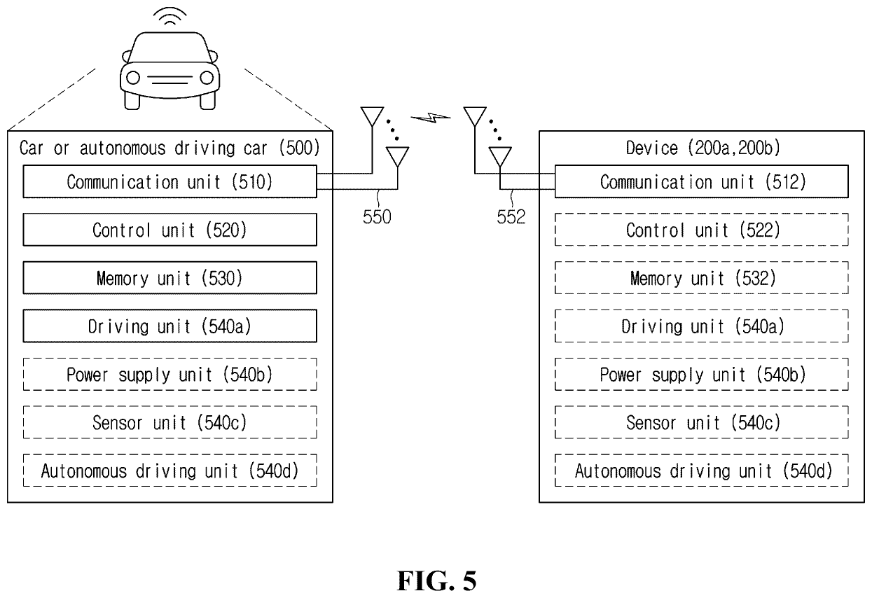

FIG. 5 illustrates an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc, and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

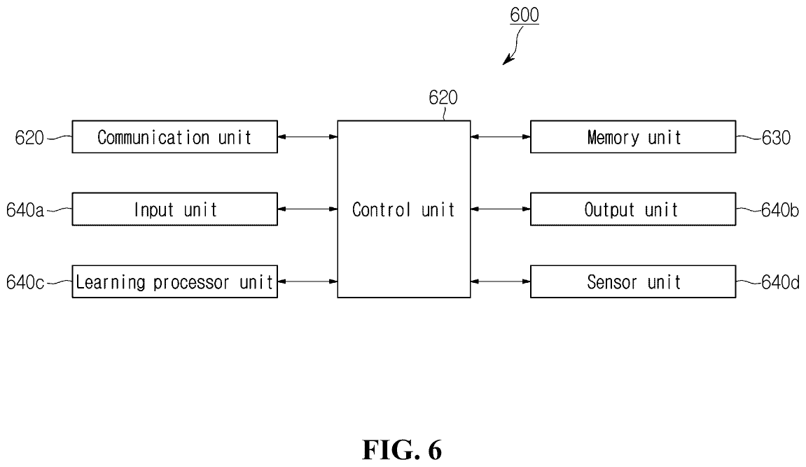

FIG. 6 is a diagram illustrating an example of an Al device applied to the present disclosure. For example, the Al device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning. input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

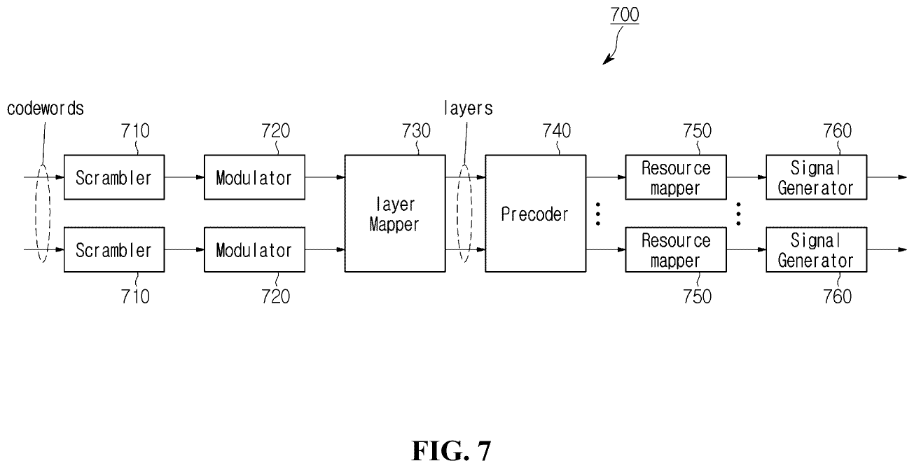

FIG. 7 illustrates a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device. (ii) a very large number of connected devices. (iii) global connectivity. (iv) very low latency. (v) decrease in energy consumption of battery-free IoT devices. (vi) ultra-reliable connectivity, and (vii) connected intelligence with machine learning capacity. The vision of the 6G system may include four aspects such as “intelligent connectivity”. “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

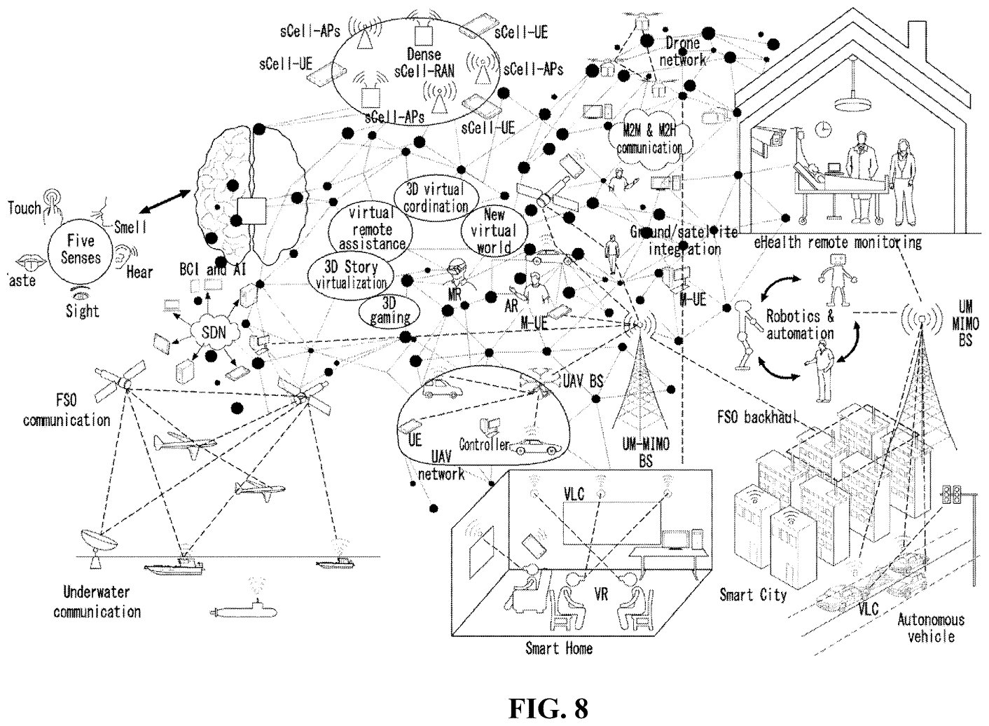

FIG. 8 illustrates an example of a communication structure providable in a 6G system applicable to the present disclosure.

Referring to FIG. 8, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. Al may use a number of analytics to determine how complex target tasks are performed. In other words, Al may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning. unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning. a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

### Terahertz (THz) Communication

THz communication is applicable to the 6G system. For example, a data rate may increase by increasing bandwidth. This may be performed by using sub-THz communication with wide bandwidth and applying advanced massive MIMO technology.

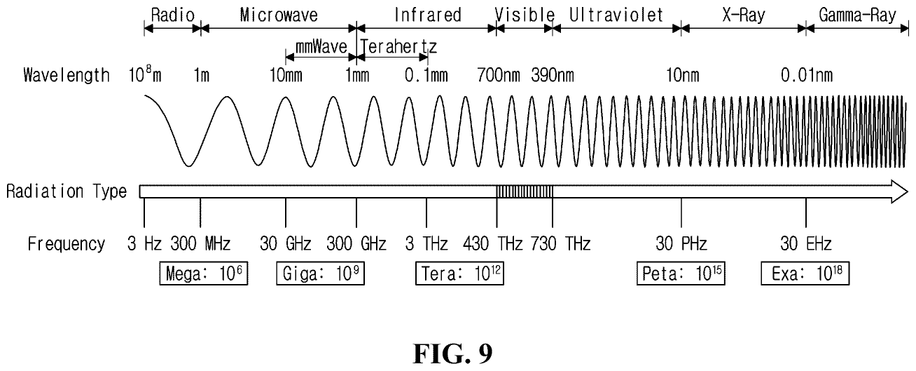

FIG. 9 illustrates an electromagnetic spectrum applicable to the present disclosure. For example, referring to FIG. 9. THz waves which are known as sub-millimeter radiation. generally indicates a frequency band between 0.1 THz and 10 THz with a corresponding wavelength in a range of 0.03 mm to 3 mm. A band range of 100 GHz to 300 GHZ (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

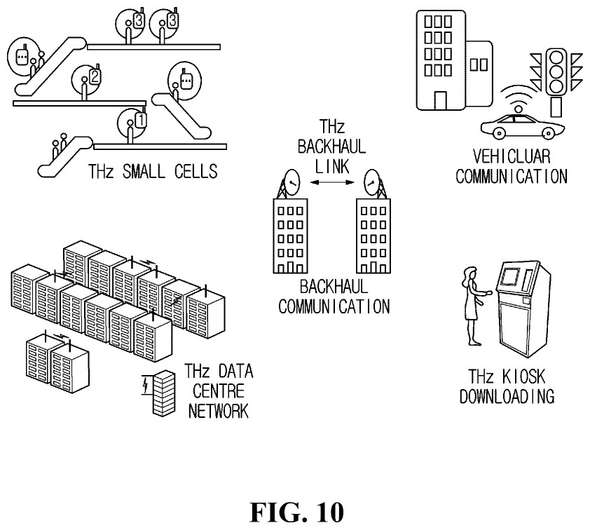

FIG. 10 illustrates a THz communication method applicable to the present disclosure.

Referring to FIG. 10. THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Artificial Intelligence System

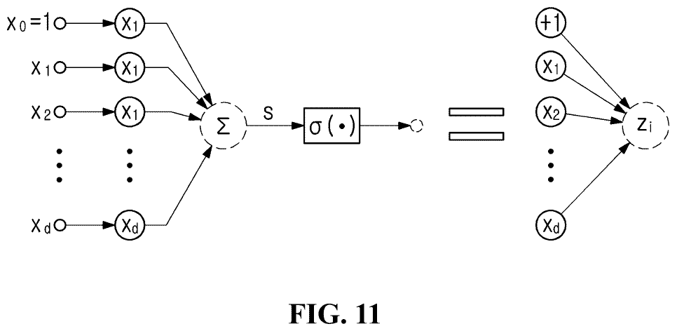

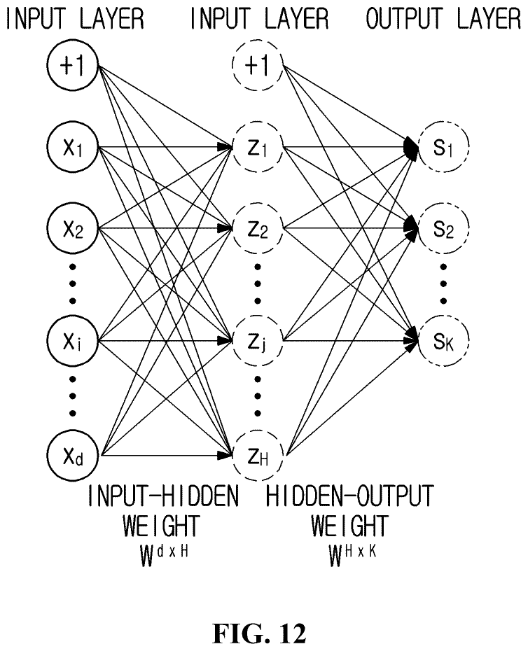

FIG. 11 illustrates a perceptron architecture in an artificial neural network applicable to the present disclosure. In addition, FIG. 12 illustrates an artificial neural network architecture applicable to the present disclosure.

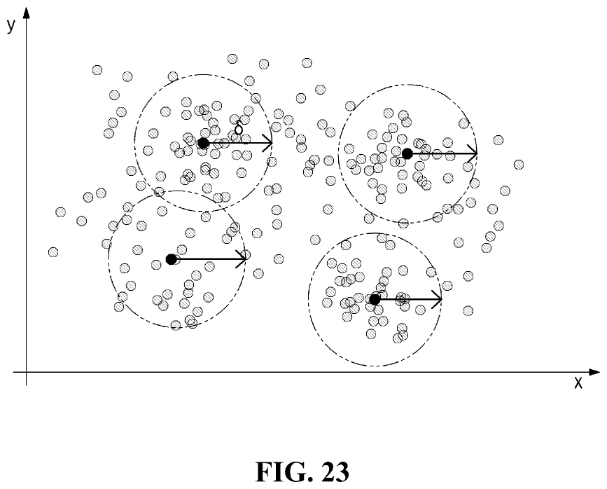

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 23, an artificial neural network may consist of a plurality of perceptrons. Herein, when an input vector x={x₁, x₂, . . . x_{d}} is input, each component is multiplied by a weight {W₁, W₂, . . . W_{d}}, results are all added up, and then an activation function σ( ) is applied, of which the overall process may be referred to as a perceptron. For a large artificial neural network architecture, when expanding the simplified perceptron structure illustrated in FIG. 11, an input may be applied to different multidimensional perceptrons. For convenience of explanation, an input value or an output value will be referred to as a node.

Meanwhile, the perceptron structure illustrated in FIG. 11 may be described to consist of a total of 3 layers based on an input value and an output value. An artificial neural network, which has H (d+1)-dimensional perceptrons between a 1st layer and a 2nd layer and K (H+1)-dimensional perceptrons between the 2nd layer and a 3rd layer, may be expressed as in FIG. 12.

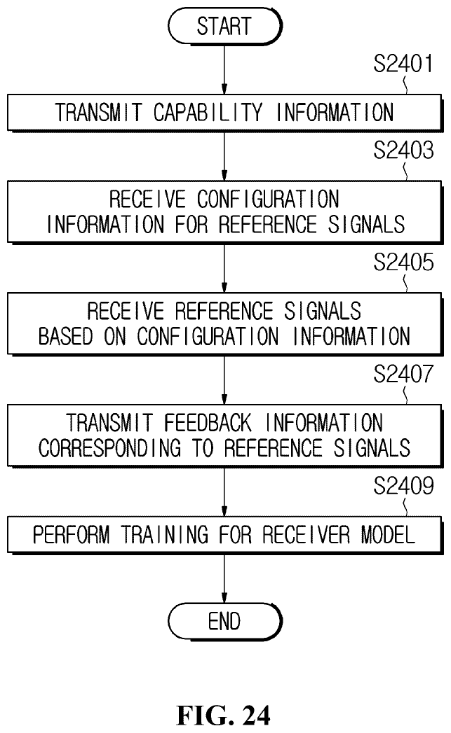

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 24, but since an input layer is excluding in counting the number of actual artificial neural network layers, it can be understood that the artificial neural network illustrated in FIG. 12 has a total of 2 layers. An artificial neural network is constructed by connecting perceptrons of a basic block two-dimensionally.

The above-described input layer, hidden layer and output layer are commonly applicable not only to multilayer perceptrons but also to various artificial neural network architectures like CNN and RNN, which will be described below: As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN).

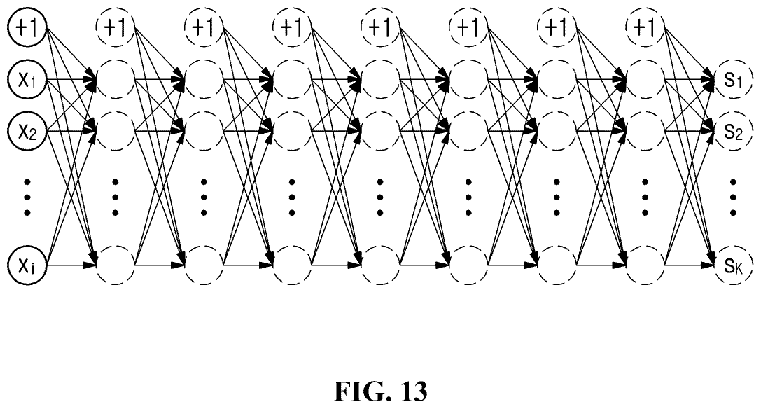

FIG. 13 illustrates a deep neural network applicable to the present disclosure.

Referring to FIG. 13, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other. A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

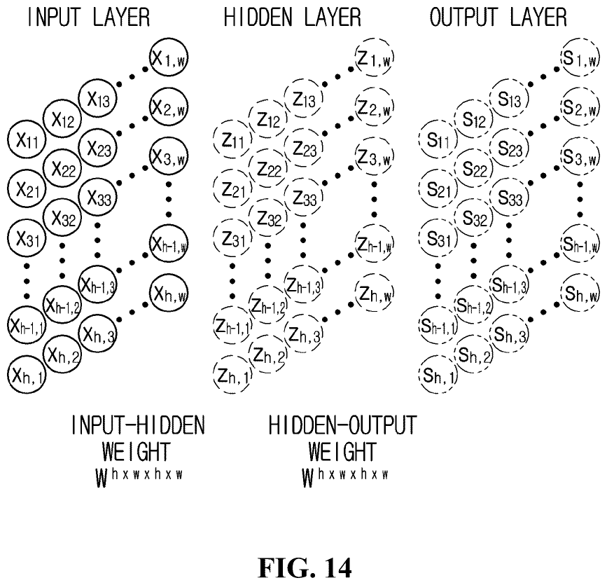

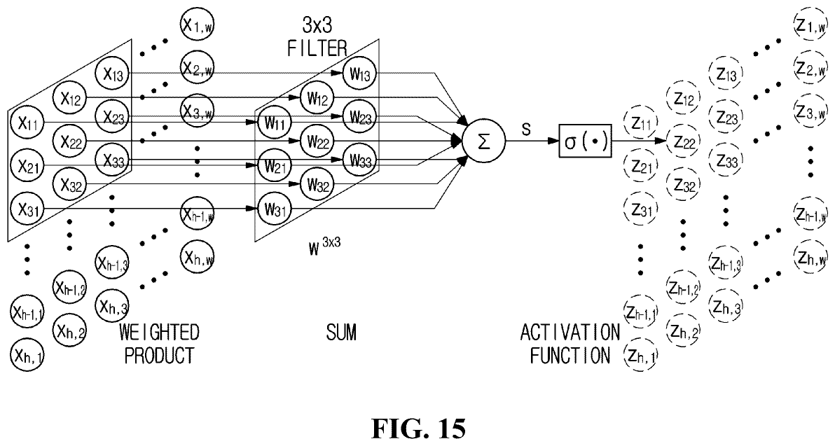

FIG. 14 illustrates a convolutional neural network applicable to the present disclosure. In addition, FIG. 15 illustrates a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 14, it is possible to assume a two-dimensional array of w horizontal nodes and h vertical nodes (the convolutional neural network structures of FIG. 14). In this case, since a weight is applied to each connection in a process of connecting one input node to a hidden layer, a total of h×w weights should be considered. As there are h×w nodes in an input layer, a total of h²w² weights may be needed between two neighboring layers.

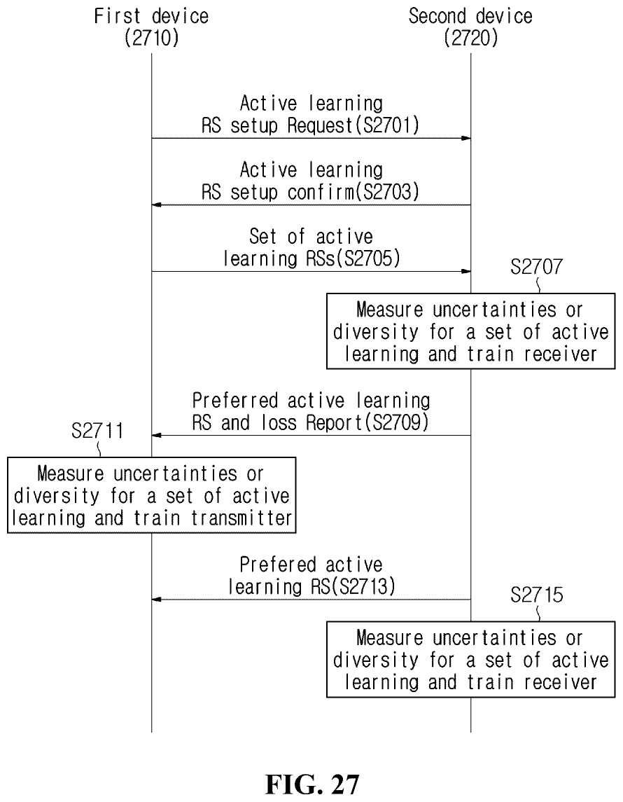

Furthermore, as the convolutional neural network of FIG. 14 has the problem of exponential increase in the number of weights according to the number of connections, the presence of a small filter may be assumed instead of considering every mode of connections between neighboring layers. As an example, as shown in FIG. 27, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 15, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence datasets and an output vector (hidden vector) output at a specific timestep is input with a very next element in the sequence, to an artificial neural network.

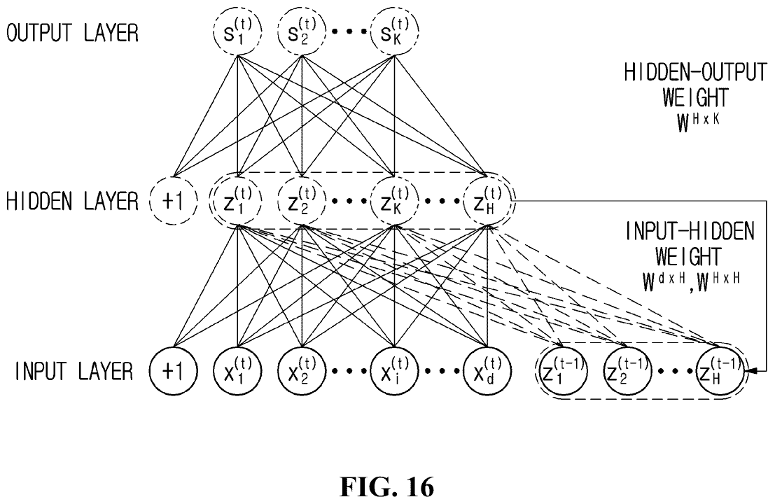

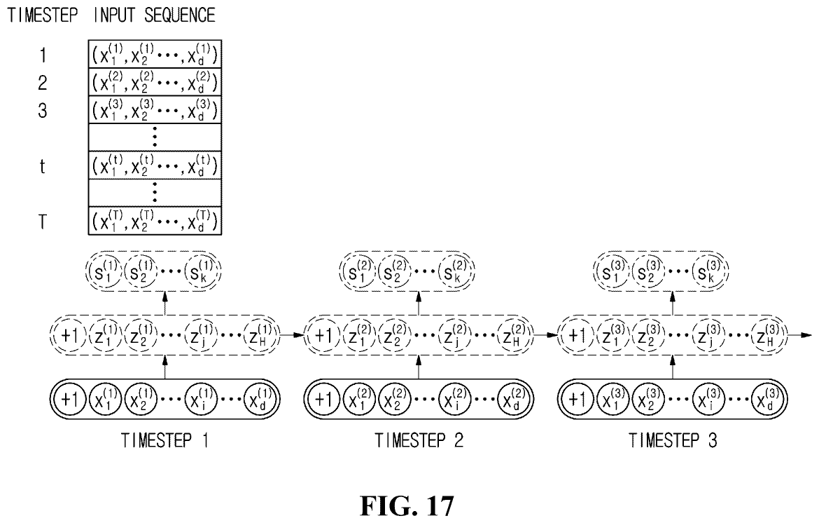

FIG. 16 illustrates a neural network architecture with a recurrent loop applicable to the present disclosure. FIG. 17 illustrates an operational structure of a recurrent neural network applicable to the present disclosure.

Referring to FIG. 16, a recurrent neural network (RNN) may have a structure which applies a weighted sum and an activation function by inputting hidden vectors {z₁^{(t-1)}, z₂^{(t-1)}, . . . , z_{H}^{(t-1)}} of an immediately previous timestep t−1 during a process of inputting elements {x₁^{(t)}, x₂^{(t)}, . . . , x_{d}^{(t)}} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 17, a recurrent neural network may operate in a predetermined timestep order for an input data sequence. Herein, as a hidden vector {z₁⁽¹⁾, z₂⁽¹⁾, . . . , z_{H}⁽¹⁾} at a time of inputting an input vector {x₁^{(t)}, x₂^{(t)}, . . . , x_{d}^{(t)}} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system. but these are concentrated in an application layer and a network layer and, especially in the case of deep learning, in a wireless resource management and allocation filed. Nevertheless, such a study gradually evolves to an MAC layer and a physical layer, and there are attempts to combine deep learning and wireless transmission especially in a physical layer. As for a fundamental signal processing and communication mechanism, Al-based physical layer transmission means application of a signal processing and communication mechanism based on an Al driver, instead of a traditional communication framework. For example, it may include deep learning-based channel coding and decoding, deep learning-based signal estimation and detection, deep learning-based MIMO mechanism, and AI-based resource scheduling and allocation.

### Specific Embodiments of the Present Disclosure

The present disclosure is directed to performing learning for a transceiver model in a wireless communication system and relates to a technology for applying active learning. Hereinafter, the present disclosure will describe various embodiments for supporting and performing active learning.

The present disclosure handles an online learning problem using a reference signal in a wireless communication system that delivers an end-to-end message by using a transmitter and a receiver that are configured as machine learning models. Herein, a machine learning model may include a neural network model. A neural network-based wireless communication system uses the feature that a neural network approximates an arbitrary function or a non-linear function well. In a situation where a message passes a wireless channel in a transmission neural network and then is received into a reception neural network, good transmission/reception performance may be obtained by using the above-described feature of a neural network well. However, in order to obtain good performance, learning of a neural network is required during actual operation. Every complex wireless channel may be covered by increasing the complexity of a model used in a terminal, but an increase of complexity will increase the burden of implementation. A model used in a terminal should be designed with an adequate degree of complexity. Meanwhile, when a terminal is moving, channel environment keeps changing over time, and thus there is a high probability that a neural network of a terminal cannot sufficiently reflect a channel feature. Accordingly, online learning is required.

General learning techniques randomly select samples from a channel data distribution when a neural network acquires training data. In this case, as a current parameter situation of a model is not sufficiently considered, a lot of training data may be used or performance accuracy may be lowered. This may cause much consumption of wireless resources to transmit many reference signals during an online training process. In order to solve the problems of performance degradation and much consumption of wireless resources, a learning process, which efficiently uses a reference signal resource by considering a situation of a model, is required for a neural network.

Thus, the present disclosure proposes that the active learning technology is applied. Active learning is a learning technique that evaluates a data distribution and the uncertainty and diversity of a model analyzing the data distribution and samples data based on an evaluation result. Especially, the present disclosure is directed to solving a problem in an active learning process, that is, the problem of disagreement between two devices, which occurs while uncertainty and diversity are evaluated. That is, the present disclosure proposes a communication system online learning technique that uses active learning to easily learn various channel propagation environments of sub-6 GHZ communication, mmWave, and THz communication.

As one type of machine learning, active learning is a technique that is performed while labeling for data for learning is performed based on interaction with a user. On the other hand, passive learning may be understood as supervised learning that uses already labeled learning data.

$$( x , y ) ∈ D \sim p ( D ) \qquad [ Formula 1 ]$$

In Formula 1, x means data, y means a label, D means a data set, and p (D) means a distribution of data sets.

In the case of passive learning, a label y for x may be added to a data set D, and samples x and y may all be given in advance in the training data set D. In the case of active learning, x is efficiently sampled in a distribution p (D) during training, and after a label y is queried to a user, the training is performed based on training data to which the queried label is added. Herein, a labeling task in active learning is referred to as annotation. When x is given in active learning, an entity, which gives information on a label y, may be referred to as ‘user’, ‘oracle’, ‘annotator’ and the like.

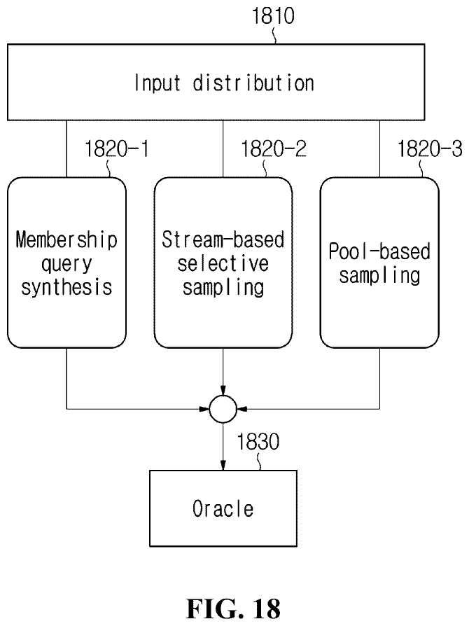

FIG. 18 illustrates sampling methods for active learning according to an embodiment of the present disclosure. FIG. 18 exemplifies three representative methods of active learning. The three methods are related to an operation of sampling data x in an input distribution 1810. Herein, the input distribution 1810 may be referred to as instance space. In membership query synthesis 1820-1, a model synthesizes a sample x belonging to the input distribution 1810 and requests a label y for the sample x to an oracle. That is, the model synthesizes the sample x and queries an oracle 1830. In stream-based selective sampling 1820-2, data x successively extracted from the input distribution 1810 are selectively distinguished, and a label y for the distinguished data x is requested to the oracle 1830. In pool-based sampling 1820-3, data x obtained from the input distribution 1810 are all included in a pool, a most advantageous sample for learning is selected in the pool, and a label y for the selected sample is requested to the oracle 1830. Thus, as a model actively participates in a data collection process, the number of samples required for training may be reduced, and performance may also be improved.

In other words, active learning may be used to reduce cost for acquiring training data. In machine learning based on data, acquiring data requires a lot of costs. If active learning is used to save such a large cost, learning ability may be improved even with a small amount of data. In addition, active learning may improve learning speed and performance.

Active sampling in active learning may be classified into two main types, that is, uncertainty sampling and diversity sampling. Uncertainty sampling is a method of enhancing effectiveness by learning most ambiguous data first, and diversity sampling is a method of learning an overall distribution quickly by sampling representative data evenly from the overall data distribution.

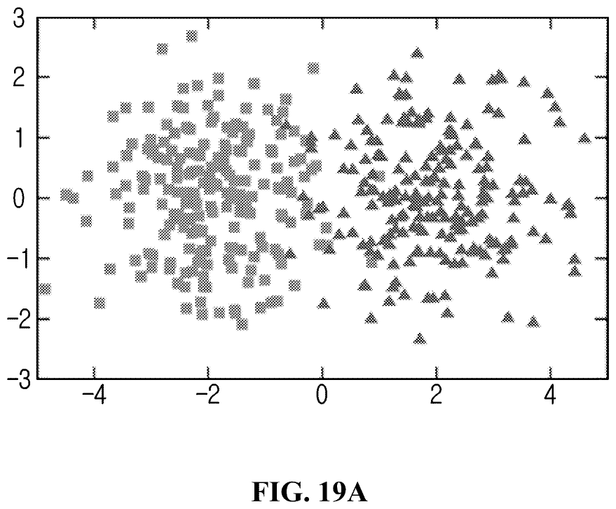

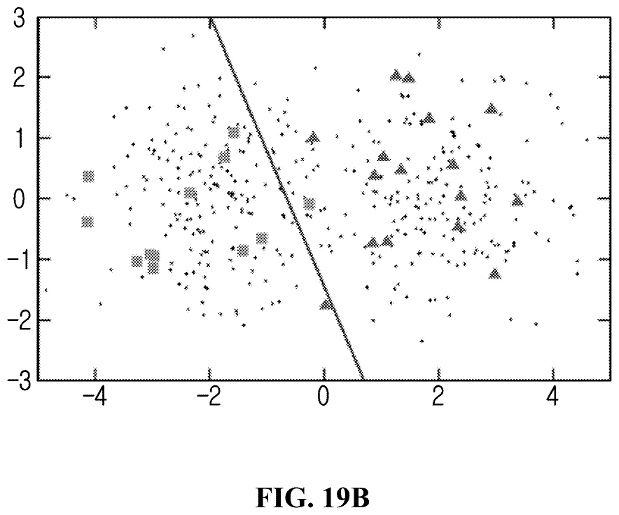

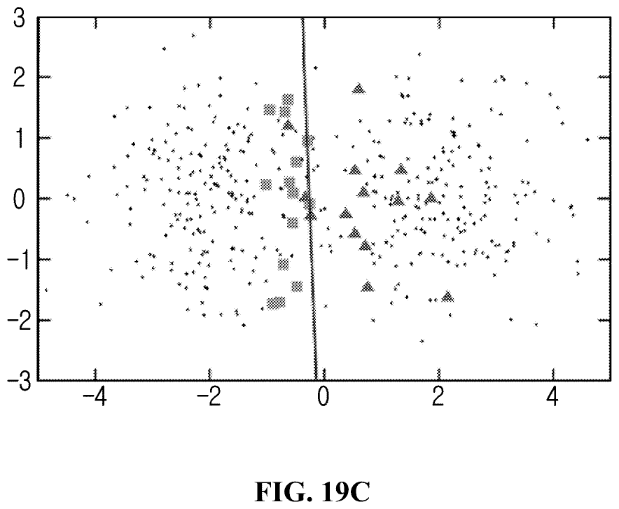

The effect of uncertainty sampling may be seen from an example of a simple binary classification task, and the binary classification task may be exemplified as in FIG. 19A to FIG. 19C. FIG. 19A to FIG. 19C illustrate examples of results of active learning and passive learning according to an embodiment of the present disclosure. FIG. 19A exemplifies an overall distribution of data sampling. As shown in FIG. 19A, learning starts after overall data are acquired by pool-based learning. FIG. 19B exemplifies a result of passive learning. As random sampling is performed, input values are evenly selected from the overall distribution so that the boundary is inaccurately learned. FIG. 19C exemplifies a result of active learning that performs sampling around regions with high uncertainty near the boundary. Referring to FIG. 19C, even when a small amount of samples are used, a good result is formed. Active learning may be applied to a regression task as well as the classification task exemplified in FIG. 19A to FIG. 19C.

The effect of active learning on uncertainty sampling has been theoretically proven by some analyzable cases. In comparison with passive learning, it is known that active learning can reduce the number of samples required for training down to a logarithmic complexity level. When an ideal case is assumed and a simple binary classifier is considered, if sampling of active learning is applied based on not full search but binary search, the reduction of complexity down to the logarithmic complexity level is expected to be achieved easily. As a more specific example, when a learning problem is considered for data that are evenly sampled from a unit spherical plane in a d-dimensional space, if a homogeneous linear separator is applied, passive learning may have a sample complexity of

$$O ( \frac{d}{ε} ) ,$$

while active learning of a query-by-committee method that makes a decision based on results of multiple models may receive data with a complexity of

$$O ( \frac{d}{ε} )$$

and then perform labeling learning for data with a complexity of

$$O ( d log ( \frac{1}{ϵ} ) ) .$$

Here, ε is a value representing error performance of a learning model.

In the present disclosure, a Bayesian model capable of quantifying uncertainty may be used to evaluate uncertainty for a sample of a model. Herein, a parameter o of a model, which is evaluated for the uncertainty of a transceiver model, is not a deterministic value but a probability variable. The learning of a Bayesian model is directed to finding a posterior probability for data, as shown in Formula 2 below.

$$p ( ϕ \vert D ) = \frac{p ( y \vert x , ϕ ) p ( ϕ )}{\int p ( y \vert x , ϕ ) p ( ϕ ) d ϕ} \qquad [ Formula 2 ]$$

In Formula 2, φ means a model parameter, D means a training data set, p(φ|D) means a prior distribution of model parameter including prior information for a model, x means data, y means an output of the model, p(y|x, φ) means a probability of y under a condition that x and φ are given, and p(φ) means a prior distribution of φ. In Formula 2, the denominator is a probability of training data, is referred to as evidence and is equal to p(D).

A predicted probability distribution p (y′|x′,D) for new data x′ may be calculated by a model conditional probability, a posterior probability of o and marginalization of the model conditional probability.

$$p ( {y}^{′} \vert {x}^{′} , D ) = \int p ( {y}^{′} \vert {x}^{′} , ϕ ) p ( ϕ \vert D ) d ϕ \qquad [ Formula 3 ]$$

In Formula 3, y′ means an output of a new model, x′ means new data, D means a training data set, and p (y|) means a probability distribution of output when training data is given.

When a predicted probability distribution is acquired, an average and a variation may be determined by using the predicted probability distribution. As the parameter o of a model is a probability variable, the uncertainty of the model is reflected. In addition, when Formula 3 is used, a variation of prediction may be determined. The variation may be used to evaluate uncertainty.

For a posterior probability of φ during training, except a linear model, closed form derivation is very difficult, and various methods for solving the problem are being proposed. Especially, an approximation method and sampling-based methods may be applied to obtaining posterior probabilities.

An acquisition function for estimating uncertainty may also be obtained by applying a Bayesian assumption. For example, an acquisition function may be obtained by reflecting a prior distribution of model in many possible acquisition functions and then integrating them.

In this case, the acquisition function ƒ_{acq}(x) is a functional that implies a Bayesian prediction distribution p (y|x,θ). Herein, as exemplified in Formula 4, an acquisition function may be a functional that performs marginalization of a prior distribution on a function. For example, the Shannon entropy may be used. In this case, uncertainty may be evaluated based on maximum entropy of a model estimate value of a given reference signal.

$$H ( y \vert x , {D}_{train} ) = - \sum p ( y = k \vert x , {D}_{train} ) log p ( y = k \vert x , {D}_{train} ) \qquad [ Formula 4 ]$$

In Formula 4, x means an input of a model, Dtrain means training data, y means an output of the model, and H(y|x, Dtrain) means entropy of y under the condition that x and Dtrain are given.

According to another embodiment, as shown in Formula 5 below, uncertainty may be evaluated based on a prediction of a model and an amount of mutual information of a model φ.

$$I ( y \vert x , ϕ , {D}_{train} ) = H ( y \vert x , {D}_{train} ) - {E}_{p ( ϕ \vert {D}_{train} )} \{ H ( y \vert x , ϕ ) \} \qquad [ Formula 5 ]$$

In Formula 5, y means an output of a model, x means an input of the model, φ means a model parameter, Dtrain means training data, I(y|x,φ,Dtrain) means an amount of mutual information when the input of the model is given, and Ep(φ|Dtrain){H(y|x,φ)} means an average of entropy for a model posterior distribution.

According to another embodiment, as shown in Formula 6 below, uncertainty may be evaluated based on a variation ratio of a model output.

$${variation}_{ratio} = 1 - max p ( y \vert x , {D}_{train} ) \qquad [ Formula 6 ]$$

In Formula 6, variationᵣₐₜᵢₒ means a variation ratio, x means an input of a model, Dtrain means training data, y means an output of the model, and max p(y|x, Dtrain) means a maximum value of a conditional probability for an output variable when the probability variable input x is given.

According to another embodiment, an acquisition function may determine a variation or a standard deviation for estimation from a Bayesian prediction distribution and estimate uncertainty based on the determined variation or standard deviation.

Apart from uncertainty sampling, diversity sampling may be used. Diversity sampling learns data capable of representing a data distribution first in order to acquire a maximum effect when every distribution of given data is learned. FIG. 23 is an example of a result that is obtained by projecting channel data in a feature space for a reference signal. Referring to FIG. 23, areas marked by black points, which may represent an overall data distribution, may be selected, and reference signals corresponding to the selected areas may be learned first.

A simple method of diversity sampling is to select a representative sample first through clustering of sample data. Like uncertainty sampling, diversity sampling may be evaluated by an acquisition function. A method of evaluating diversity sampling may be performed based on a clustering technique after a distance caused by a loss is defined in data space. An acquisition function ƒ_{acq}(x) for diversity sampling selects representative data in an active learning reference signal distribution from the optimization perspective of a learning distribution distance between active learning reference signal sets. That is, an acquisition function for diversity sampling outputs representativeness of an input sample. Based on the output of the acquisition function, transmission of a reference signal for a wireless resource with highest diversity may be requested to a transmitter.

When online learning is performed based on data in a communication system, solution to a problem of active learning is required. Sampling and labeling in communication may be defined by transmission between a transmitter and a receiver. When a reference signal is transmitted between a transmitter and a receiver, it is desirable that the use of a wireless resource should be minimized in a task of estimating a channel by using the reference signal.

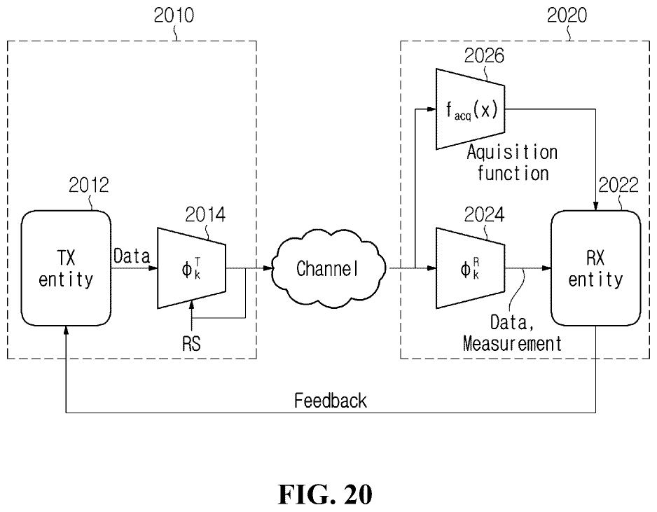

FIG. 20 illustrates functional structures of devices supporting active learning according to an embodiment of the present disclosure. FIG. 20 exemplifies a transmission/reception model in which, of two devices 2010 and 2020 performing communication according to an embodiment, the first device 2010 functions as transmitter, and the second device 2020 functions as a receiver. In downlink communication, the first device 2010 and the second device 2020 may be understood as a base station and a UE respectively. In uplink communication, the first device 2010 and the second device 2020 may be understood as a UE and a base station respectively. The transmission/reception model of FIG. 20 includes a model parameter

$${ϕ}_{k}^{T}$$

of a transmitter and a model parameter

$${ϕ}_{k}^{R}$$

of a receiver for an active learning reference signal set element k at a specific time. Herein, k is an index indicating one of K reference signal types in operation.

Referring to FIG. 20, the first device 2010 includes a transmit entity 2012 and a transmitter model 2014. The transmit entity 2012 performs overall control and processing for data transmission. For example, the transmit entity 2012 may generate transmission data and interpret feedback information received from the second device 2020. The transmitter model 2014 is a data processing block implemented as a neural network. The transmitter model 2014 generates a signal that includes at least one of data and a reference signal.

The second device 2020 includes a receive entity 2022, a receiver model 2024 and an evaluation unit 2026. The receive entity 2022 performs overall control and processing for data reception. For example, the transmit entity 2012 may generate feedback information to be provided to the first device 2010. For example, the feedback information may include at least one of a preferred active reference signal (RS), active learning parameters, or information related to loss. The receiver model 2024 is a data processing block implemented as a neural network. The receiver model 2022 may reconstruct data from a data signal received from the first device 2010 and perform measurement for a reference signal. The evaluation unit 2026 evaluates a signal received from the first device 2010. An evaluation result may include information indicating uncertainty used for uncertainty sampling or information necessary for selecting representative data used for diversity sampling.

In the reference signal set D [symbol] (x,y), p(D) for active learning, the independent variable vector x is a vector, which is generated based on at least one of frequency, time, antenna or context information of the devices 2010 and 2020 or a combination thereof, and corresponds to a pattern of a reference signal allocated to a wireless resource. The pattern of the reference signal may be interpreted in various ways. For example, the pattern may indicate a distribution of reference signals in a given resource region or each unit resource (e.g., RE) in a resource region. Herein, the context information may include a location of a terminal, acceleration, velocity, and posture information of the terminal, which affect channel data sampling, y is a reception signal. A reference signal set for active learning determines efficiency of a wireless resource according to the density of a pattern based on the independent variable x.

In FIG. 20,

$${ϕ}_{k}^{T}$$

is a parameter of a transmitter neural network applied to the transmitter model 2014. It serves as a type of precoding for the active learning reference signal k and a data transmission signal.

$${ϕ}_{k}^{R}$$

is a parameter of a receiver neural network applied to the receiver model 2024. A receiver knows the active learning reference signal transmitted by a transmitter.

$${ϕ}_{k}^{T} and {ϕ}_{k}^{R}$$

may be learned by performing a stochastic gradient method to achieve optimization

$${arg max L}_{{ϕ}_{k}^{T} , {ϕ}_{k}^{R}} ( {D}_{RS} , {ϕ}_{k}^{T} , {ϕ}_{k}^{R} )$$

of an overall loss function by using an active learning reference signal data set DRS. ƒ_{acq}(x) is an acquisition function applied to the evaluation unit 2026. ƒ_{acq}(x) has the Bayesian assumption, but the models

$${ϕ}_{k}^{T} and {ϕ}_{k}^{R}$$

do not necessarily need the Bayesian assumption. That is, in case ƒ_{acq}(x) measures uncertainty, whatever type of a transceiver is given, uncertainty may be evaluated while the transceiver is interpreted as Bayesian.

ƒ_{acq}(x) evaluates a reception signal based on a transmitter model and a receiver model. Based on a result of ƒ_{acq}(x), a reference signal pattem with lowest wireless resource consumption from the perspective of the transmitter and receiver models may be required to the transmitter side.

Accordingly, ƒ_{acq}(x) may be designed to reflect the transceiver models

$${ϕ}_{k}^{T} and {ϕ}_{k}^{R} .$$

If uncertainty sampling based on a Bayesian method is reflected, ƒ_{acq}(x) may include a prior distribution for the transceiver models

$${ϕ}_{k}^{T} and {ϕ}_{k}^{R} ,$$

and herein the transceiver models

$${ϕ}_{k}^{T} and {ϕ}_{k}^{R}$$

may have a fixed value corresponding to a prior distribution average value. If diversity sampling is reflected, ƒ_{acq}(x) may evaluate representativeness from the perspective of the transceiver models

$${ϕ}_{k}^{T} and {ϕ}_{k}^{R} .$$

In this case, when an active leaming reference signal pattern is learned through the transceiver models

$${ϕ}_{k}^{T} and {ϕ}_{k}^{R} ,$$

representativeness may be evaluated by statistically clustering a reference signal pattern. Based on evaluation by ƒ_{acq}(x), a preferred sample (e.g., reference signal pattern) may be determined according to one of uncertainty sampling and diversity sampling.

In the case of uncertainty sampling, a reference signal pattern with highest uncertainty from the perspective of transmitter and receiver models is learned. When a plurality of sets of active learning reference signals are received, the second device 2020 may evaluate uncertainty of each set and request active learning reference signals, which belong to at least one set with high uncertainty, to the first device 2010. To this end, an acquisition function model ƒ_{acq}(x) of a receiver evaluates uncertainty of a model

$${ϕ}_{k}^{R}$$

for an active learning reference signal. The acquisition function ƒ_{acq}(x) includes model information

$${ϕ}_{k}^{R} .$$

Based on uncertainty, the acquisition function ƒ_{acq}(x) may determine uncertainty for the model

$${ϕ}_{k}^{R}$$

for a data sample including a reference signal pattern represented by time and frequency resources for at least one antenna port for transmitting active reference signals. Then, transmission of reference signals for a wireless resource with highest uncertainty may be requested to the first device 2010 that operates as a transmitter.

Diversity sampling may be interpreted as a clustering problem. x*=ƒ_{acq}(x∈X;φδ) is given as an acquisition function. FIG. 23 illustrates an example of clustering according to an embodiment of the present disclosure. Referring to FIG. 23, xc is a center point of a circle with a radius of δ. Diversity sampling selects an active learning reference signal pattern x* corresponding to the center point that minimizes δ. An approximation learning method for diversity sampling may be a k-center clustering algorithm. When k points or patterns are selected, a distance covering all other points is preferably minimized. That is, when diversity sampling is performed, an active learning reference signal set capable of representing a data distribution needs to be transmitted and received. ƒ_{acq}(x) selects representative data from an active learning reference signal distribution from the optimization perspective of a learning distribution distance between active learning reference signal sets. Based on this, transmission of a reference signal for a wireless resource with highest diversity may be requested to a transmitter.

As online learning is performed, the models

$${ϕ}_{k}^{T} and {ϕ}_{k}^{R}$$

are renewed according to time. In addition, because the contents of the models

$${ϕ}_{k}^{T} and {ϕ}_{k}^{R}$$

are reflected in ƒ_{acq}(x), ƒ_{acq}(x) may also be renewed.

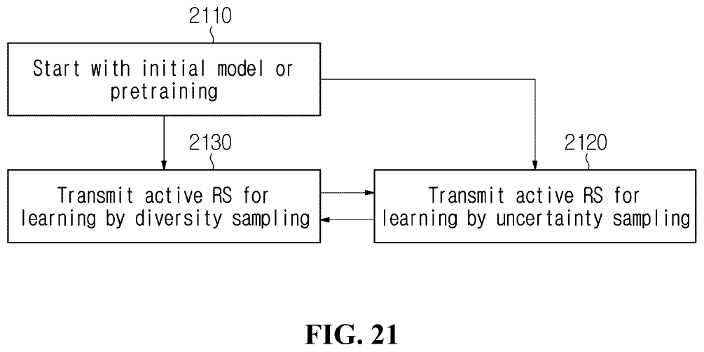

FIG. 21 illustrates an example of state transition by active learning according to an embodiment of the present disclosure. FIG. 21 exemplifies state transition in active learning of a transmitter and a receiver (e.g., the first device 2010 and the second device 2020 of FIG. 20).

Referring to FIG. 21, a first state 2110 is an initial state and is a state in which pretraining of a transmitter and a receiver is performed or an initial model is used. The transmitter and the receiver may download a pretrained model or acquire a pretrained model through a model identifier that is agreed between the transmitter and the receiver. Alternatively, the transmitter and the receiver may perform pretraining through an active learning reference signal. A state may be subject to a transition from the first state 2110 to a second state 2120 or a third state 2130. In addition, there may be a state transition between the second state 2120 and the third state 2130.

The second state 2120 is a state in which an active reference signal for learning by uncertainty sampling is transmitted. When uncertainty is evaluated, an acquisition function reflects current uncertainty of a transmitter model and a receiver model, instead of reflecting a stochastic feature of noise or channel. Uncertainty is caused by an assumption of a model. Whenever a terminal model moves in a urban area by a car or moves in a sub-urban area by walk, if a neural network weight and a distribution of bias are investigated beforehand and an investigation result is provided to an acquisition function as a prior distribution, the acquisition function may evaluate uncertainty based on it through a Bayesian method. The third state 2130 is a state in which an active reference signal for learning by diversity sampling is transmitted. A transmitter and a receiver may selectively enter the states 2120 and 2130 for diversity sampling or uncertainty sampling. In addition, a state transition between diversity sampling and uncertainty sampling may be performed to maximize a final reward from the perspective of reinforcement learning.

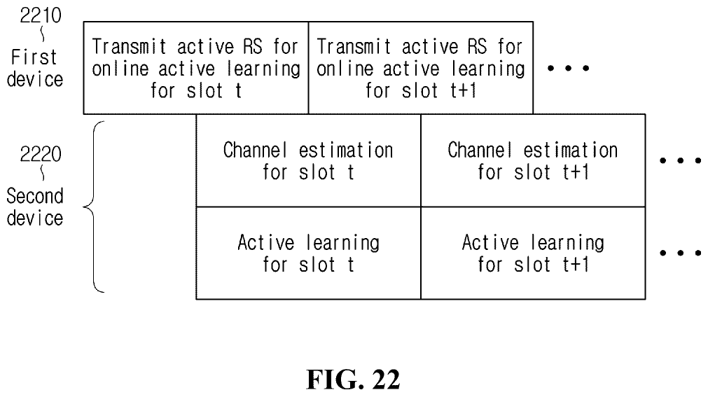

FIG. 22 illustrates an example of operation timing of active reference signal transmission and channel estimation according to an embodiment of the present disclosure. A first device 2210, which is a transmitter, and a second device 2220, which is a receiver, may operate in a pipeline form over time as shown in FIG. 22. The second device 2220 receives an active learning reference signal, performs channel estimation and then renews a model. At the same time, the second device 2220 performs measurement for performing uncertainty sampling or diversity sampling. The second device 2220 requests at least one active reference signal pattern using a wireless resource least in active learning reference signal sets to the first device 2210. That is, the second device 2220 may request a preferred active learning reference signal pattern to the first device 2210. Herein, the preferred active learning reference signal pattern may be determined as in Formula 7 below:

$${x}^{*} = arg max {f}_{acq} ( x ; ϕ ) , {D}_{x} ∋ x \qquad [ Formula 7 ]$$

In Formula 7, x* means a pattern of a preferred active learning reference signal, facq(x;φ) means an output of an acquisition function for x when a model is in a state of φ. Dx means a set of reference signal patterns, and x means a reference signal pattern. Here, x may be one reference signal consisting of an antenna, a frequency and time or one of a plurality of reference signal patterns.

In uncertainty sampling, ƒ_{acq}(x,φ) may be defined as H(y|x,Dtrain), I(v,θ|x,Dtrain) and the like, and a form of all relevant acquisition functions may be agreed through mutual signaling between a transmitter and a receiver. An acquisition function may be obtained through a model output and marginalization of a model distribution φ, as shown in Formula 8 below.

$$p ( y \vert {D}_{train} ) = \int p ( y \vert x , {ϕ}^{′} ) p ( {ϕ}^{′} \vert {D}_{train} ) d {ϕ}^{′} \qquad [ Formula 8 ]$$

In Formula 8, y means an output of a model, Dtrain means training data, x means an input of the model, and φ′ means an integral dummy variable for marginalizing a model parameter.

In the case of a Bayesian neural network, one of various methods may be adopted to approximate a posterior probability for a model parameter. Like Formula 9 below, Formula 8 may be expressed by approximate posterior probability monte-carlo drop-out sampling.

$$p ( y \vert {D}_{train} ) \approx \int p ( y \vert x , {ϕ}^{′} ) {q}_{θ} ( {ϕ}^{′} ) d {ϕ}^{′} \approx \sum p ( y \vert {ϕ}_{i} ) \qquad [ Formula 9 ]$$

In Formula 9, y means an output of a model, Dtrain means training data, x means an input of the model, φ′ means an integral dummy variable for marginalizing a model parameter, and qθ(φ′) means a drop-out prior distribution of a neural network parameter.

FIG. 24 illustrates an example of a procedure of performing learning for a transmitter model or a receiver model according to an embodiment of the present disclosure. FIG. 24 exemplifies an operating method of a UE, and operations exemplified herein may be understood as operations of a receiver (e.g., the receiver 2020 of FIG. 20).

Referring to FIG. 24, at step S2401, the UE transmits capability information. In other words, the UE transmits a message including the capability information. The capability information may include information related to a communication-related capability of the UE. According to an embodiment, the capability information may include information related to active learning. For example, the information related to active learning may include at least one of information indicating at least one supportable learning model, information indicating at least one supportable reference signal pattern, information indicating at least one supportable sampling method, or information indicating a feature (e.g., prior distribution) of at least one supportable learning model. Although not illustrated in FIG. 24, before transmitting the capability information, the UE may receive a message for requesting the capability information from a base station.

At step S2403, the UE receives configuration information for reference signals. The UE receives a message including the configuration information for the reference signals, which is transmitted by the base station. The configuration information may include at least one of information related to resources allocated for the reference signals, information related to an operation required in response to reception of the reference signals, or information related to an item requiring measurement or feedback. According to an embodiment, the configuration information may include information related to a pattern of the reference signals, information related to a model for active learning (e.g., model identifier), a request to perform active learning, information related to an acquisition function for evaluating uncertainty or diversity, and a request for feedback indicating a preferred reference signal pattern.

At step S2405, the UE receives the reference signals based on the configuration information. The UE receives the reference signals through resources that are indicated by the configuration information. Herein, the reference signals may have at least one pattern. According to an embodiment, as a distribution of reference signals belonging to one set, a pattern may indicate at least one of the number of the reference signals, a density of the reference signals, a spacing on a frequency axis of the reference signals, a spacing on a time axis of the reference signals, or resource element (RE) positions allocated to the reference signals. According to another embodiment, a pattern may indicate one of REs to which a reference signal may be mapped. According to another embodiment, as a configuration for reference signals, a pattern may indicate at least one of a transmission power, a sequence, a covering code, or a slot interval at which the reference signals are transmitted. According to another embodiment, a pattern may indicate a relation with an adjacent cell (e.g., using a resource without interference with the adjacent cell). For example, at least one pattern applied to the reference signals received at this step may include patterns used for pretraining or at least one pattern specified by the UE.

At step S2407, the UE transmits feedback information corresponding to the reference signals. The UE may transmit the feedback information after processing the reference signals. The feedback information may include at least one of a measurement result for the reference signals or a request for subsequent reference signal transmission. According to an embodiment, the UE may perform a predicting operation for the reference signals by using a receiver model and determine an uncertainty metric or a diversity metric for a prediction result. In addition, the UE may determine at least one preferred reference signal pattern based on the uncertainty metric or diversity metric and transmit feedback information including information related to the at least one preferred reference signal. In addition, the feedback information may include, as a measurement result for the reference signals, a loss value determined based on the prediction result and an error between labels (e.g., transmission values of reference signals).

At step S2409, the UE performs training for the receiver model. According to an embodiment, the UE may perform training for the receiver model by using the reference signals that are received at step S2405. In addition, the UE may perform training for the receiver model by using reference signals that are additionally received. Herein, the additionally received reference signals may have at least one reference signal pattern that is requested by the feedback information. Specifically, the UE may determine a loss value of a prediction result for reference signals and perform a back-propagation operation based on the loss value, thereby renewing weights of a receiver model.

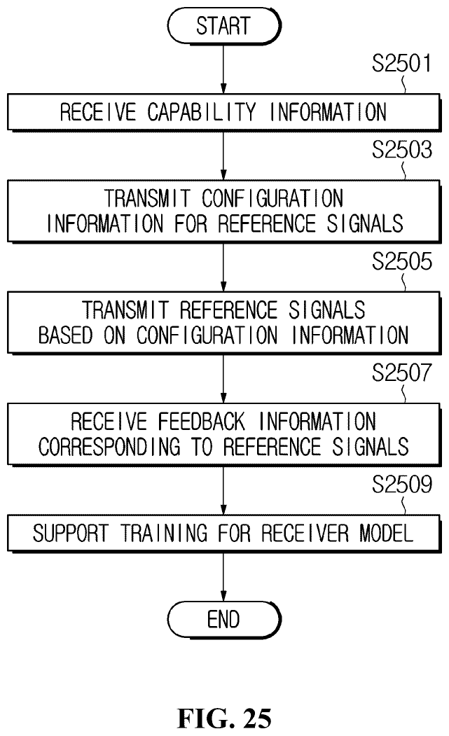

FIG. 25 illustrates an example of a procedure of supporting learning for a transmitter model or a receiver model according to an embodiment of the present disclosure. FIG. 25 exemplifies an operating method of a base station, and operations exemplified herein may be understood as operations of a receiver (e.g., the receiver 2020 of FIG. 20).

Referring to FIG. 25, at step S2501, the base station receives capability information. In other words, the base station receives a message including the capability information of a UE. The capability information may include information related to a communication-related capability of the UE. According to an embodiment, the capability information may include information related to active learning. For example, the information related to active learning may include at least one of information indicating at least one supportable learning model. information indicating at least one supportable reference signal pattern, information indicating at least one supportable sampling method, or information indicating a feature (e.g., prior distribution) of at least one supportable learning model. Although not illustrated in FIG. 25, before receiving the capability information, the base station may transmit a message for requesting the capability information to the UE.

At step S2503, the base station transmits configuration information for reference signals. The base station transmits a message including the configuration information for the reference signals to be transmitted later. The configuration information may include at least one of information related to resources allocated for the reference signals, information related to an operation required in response to reception of the reference signals, or information related to an item requiring measurement or feedback. According to an embodiment, the configuration information may include information related to a pattern of the reference signals, information related to a model for active learning (e.g., model identifier), a request to perform active learning, information related to an acquisition function for evaluating uncertainty or diversity, and a request for feedback indicating a preferred reference signal pattern.

At step S2505, the base station transmits the reference signals based on the configuration information. The base station transmits the reference signals through resources indicated by the configuration information. Herein, the reference signals may have at least one pattern. Herein, a pattern means the number of reference signals belonging to one set, a density, and mapped RE positions. For example, at least one pattern applied to the reference signals received at this step may include patterns used for pretraining or at least one pattern specified by the UE.

At step S2507, the base station receives feedback information corresponding to the reference signals. The feedback information may include at least one of a measurement result for the reference signals and a request for subsequent reference signal transmission. According to an embodiment, the feedback information may include information related to at least one preferred reference signal pattern selected by the UE. In addition, the feedback information include, as a measurement result for the reference signals, a loss value for a prediction result in the UE.

At step S2509, the base station supports training for at least one receiver model. According to an embodiment, the base station may transmit reference signals for training of a receiver model in the UE. Herein, the transmitted reference signals may have at least one reference signal pattern requested by the feedback information.

According to the embodiments described with reference to FIG. 24 and FIG. 25, training may be performed for a receiver model. Additionally, training may also be performed for a transmitter model used by a base station. According to an embodiment, a UE may transmit a loss value for a prediction result to a base station, and the base station may perform training for a transmitter based on the received loss value. Alternatively, according to another embodiment, after a UE performs training for a transmitter model, the UE may transmit information on weights renewed through the training to a base station.

The embodiments described with reference to FIG. 24 and FIG. 25 may be performed for training for a transceiver model for downlink communication. In case a transceiver model for uplink communication is used, the transceiver model for uplink communication may also be trained through a similar procedure. In this case, as a base station has a receiver model and a UE has a transmitter model, the base station may request a preferred reference signal pattern to the UE, the UE may transmit an uplink reference signal, and the base station may perform training for the receiver model.

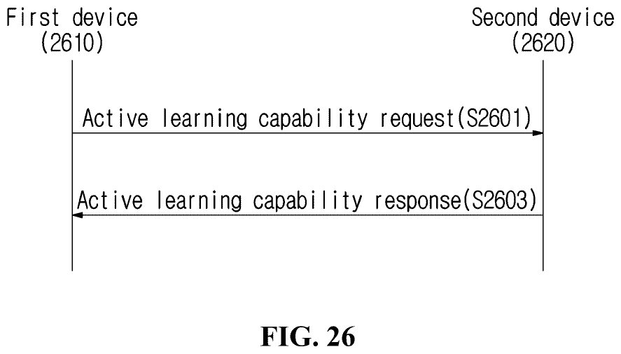

FIG. 26 illustrates an example of a procedure of providing capability information for active learning according to an embodiment of the present disclosure. FIG. 26 exemplifies signaling for mutually supporting initial active learning between a first device 2610 and a second device 2620.

Referring to FIG. 25, at step S2601, the first device 2610 transmits an active learning capability request message to the second device 2620. After the second device 2620 accesses the first device 2620, the active learning capability request message may be transmitted during a registration procedure or after registration. Herein, the active learning capability request message may be referred to as a capability enquiry message.

At step S2603, the second device 2620 transmits an active learning capability response message to the first device 2610. The active learning capability response message includes information on a capability supported in the second device 2620 for active learning. For example, the active learning capability response message may include at least one of information related to at least one machine learning model to which active learning is applicable, information related to at least one reference signal pattern supportable for active learning, information related to a supportable sampling method (e.g., at least one of uncertainty sampling and diversity sampling), and information related to a sampling-related acquisition function that is supportable according to a model. The active learning capability response message may be referred to as a capability information message. In this case, the active learning capability response message may further include various capability information other than active learning.

As described with reference to FIG. 26, capability information related to active learning of the second device 2620 may be provided. In addition, capability information related to active learning of the first device 2610 may be provided to the second device 2620 through an active learning capability request message. In this case, according to an embodiment, the active learning capability request message may include capability information belonging to a range that is commonly supported by the first device 2610 and the second device 2620. Accordingly, items of information elements (IEs) or parameters included in an active learning capability request message or an active learning capability response message may include at least one of the items listed in Table 2 below:

TABLE 2

| Information element | Description |
|---|---|
| Support of model | indicates a model set capable of active learning in a |
| set | machine learning model set that can be mutually |
| | supported. |
| Supported a set of | indicates a model set capable of active learning in a |
| active learning | machine learning model set that can be mutually |
| reference signal | supported. |
| Supported sampling | indicates whether uncertainty sampling and diversity |
| mode | sampling can be supported. |
| Supported sampling | includes mutual agreement information for a |
| information | sampling-related acquisition function that is |
| | supportable according to a model. In case of |
| | uncertainty sampling, partial information of possible |
| | prior distribution p(φ\|Dtrain) is delivered. In case of |
| | diversity sampling, an optimization objective |
| | function for cluster is delivered. |

FIG. 27 illustrates an example of a procedure of performing active learning according to an embodiment of the present disclosure. FIG. 27 exemplifies signaling for performing active learning between a first device 2710 and a second device 2720.

Referring to FIG. 27, at step S2701, the first device 2710 transmits an active learning RS setup request message to the second device 2720. The active learning RS setup request message notifies the start of a procedure of selecting at least one RS pattern for active learning. The active learning RS setup request message may include information related to candidate RS patterns to be transmitted later (e.g., resource information, sequence information, etc.). The active learning RS setup request message may be referred to as a measurement configuration message.

At step S2703, the second device 2720 transmits an active learning RS setup confirm message to the first device 2710. That is, the second device 2720 receives reference signals according to candidate RS patterns for active learning and notifies that a preferred RS pattern may be selected. The active learning RS setup confirm message may be understood as ACK for the active learning RS setup request message. That is, the second device 2720 informs the first device 2710 of acceptance of an active learning procedure. Next, from the perspective of online learning, the transmission of learning of active learning reference signals may be repeated as follows.

At step S2705, the first device 2710 transmits sets of active learning reference signals to the second device 2720. That is, the first device 2710 transmits reference signals according to supportable RS patterns. Herein, the first device 2710 may transmit reference signals based on information that is delivered through the active learning RS setup request message.

At step S2707, the second device 2720) measures uncertainty or diversity for active learning and trains a receiver model. The second device 2720 may measure uncertainty or diversity according to each candidate RS pattern. Herein, whether uncertainty or diversity becomes a measurement target may be determined according to an applied sampling method. By measuring uncertainty or diversity, the second device 2720 may determine which RS pattern is further needed for subsequent training.

At step S2709, the second device 2720 reports information on a preferred active learning reference signal and a loss to the first device 2710. In other words, the second device 2720 transmits information indicating a preferred active learning RS pattern among preferred candidate RS patterns and also transmits loss information for training a transmitter model of the first device 2710. The preferred active learning RS pattern includes at least RS pattern that has a highest acquisition function result value. A loss is determined by a predefined loss function, and for example, the loss function may be defined based on a difference between a predicted value of a receiver model and a label.

At step S2711, the first device 2710 measures uncertainty or diversity for active learning and trains a transmitter model. The first device 2710 may train a transmitter model based on the measured uncertainty or diversity and loss information received from the second device 2720. That is, the first device 2710 may select a preferred active learning RS pattern based on the measured uncertainty or diversity and train the transmitter model by using the selected RS pattern. Herein, it is desirable that an acquisition function used in the first device 2710 has a same prior distribution as an acquisition function used in the second device 2720.

At step S2713, the first device 2710 transmits preferred active learning reference signals to the second device 2720. The first device 2710 transmits reference signals according to a RS pattern that is requested by the second device 2720. Herein, the preferred active learning reference signals may be transmitted through a preconfigured resource. Alternatively, the first device 2710 may transmit resource information for the preferred active learning reference signals first and then transmit the preferred active learning reference signals.

At step S2715, the second device 2720 measures uncertainty or diversity for active learning and trains a receiver model. That is, the second device 2720 may measure uncertainty or diversity according to each received RS pattern. Herein, whether uncertainty or diversity becomes a measurement target may be determined according to an applied sampling method. By measuring uncertainty or diversity, the second device 2720 may determine which RS pattern is further needed for subsequent training.

As described with reference to FIG. 27, the first device 2710 sequentially transmits reference signals of each pattern included in a pre-arranged active learning RS pattern set. The second device 2720 evaluates uncertainty for an active learning reference signal of each pattern and delivers a measurement report about at least one preferred active learning RS pattern to the first device 2710. According to an embodiment, preference of an active learning RS pattern may depend on density or an amount of wireless resources. For example, a RS pattern occupying a small wireless resource may be preferred. Based on the measurement report of the second device 2720, the first device 2710 transmits active learning reference signals of a pattern using as a small amount of wireless resource as possible. Thus, a transmitter model and a receiver model may be trained, items of information elements or parameters, which may be exchanged through the procedure exemplified in FIG. 27, may include at least one of the items listed in Table 3 below.

TABLE 3

| Information element | Description |
|---|---|
| Learning model | indicates a model for active learning or a related |
| | identifier. |
| A set of active | indicates an active learning reference signal set |
| learning reference | D [symbol] (x, y). D means a plurality of pattern sets of |
| signal | reference signals with different densities or a related |
| | identifier. |
| Uncertainty | indicates a prior distribution p(φ \| Dtrain) of a |
| sampling | transceiver model parameter and region information |
| information | (e.g., layer information of a neural network) of a |
| | model to which the prior distribution is to be |
| | applied. This indicates a type of an acquisition |
| | function for evaluating uncertainty between a |
| | transmitter and a receiver and a method of |
| | approximating the acquisition function. |
| Diversity sampling | For information for diversity sampling, a transmitter |
| information | and a receiver indicate an optimization function type |
| | for representative sampling between the transmitter |
| | and the receiver. |

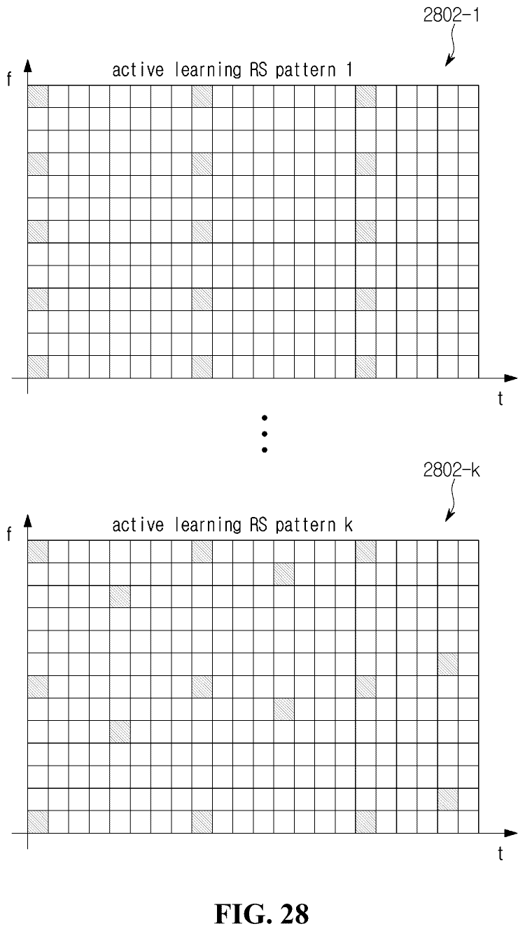

According to the above-described various embodiments, a transmitter and a receiver with a neural network structure may be trained. The above-described embodiments may be applied to a base station and a terminal. In this case, a base station having a transmitter with a neural network structure may transmit downlink active learning reference signals to a receiver of a terminal. For a first active learning pattern, as shown in FIG. 28, a set of various k patterns in an antenna port may be successively transmitted. FIG. 28 illustrates examples of reference signal patterns for active learning according to an embodiment of the present disclosure. Referring to FIG. 28, k reference signal patterns 2802-1 to 2802-k may be defined. The reference signal patterns 2802-1 to 2802-k are different from each other with respect to a location of a resource to which the reference signals are mapped, an amount of resources, and a resolution of a frequency axis or time axis of the reference signals. However, the definition of patterns as shown in FIG. 28 is merely one example, and a difference between patterns may be differently defined or expressed according to various embodiments.

For active learning between a base station and a terminal, an initial preheating process is needed. As a characteristic of communication, a reference signal is delivered in a stream form, and it is because selective sampling is applied. The initial preheating process shows representative samples that are necessary for a terminal to estimate a channel, and this may be understood as application of the concept of diversity sampling. The initial preheating process may be referred to as pretraining. When pretraining is completed, a terminal evaluates uncertainty for each active learning reference signal pattern, selects a pattern with high uncertainty and a smallest density of reference signals and then notifies the selected pattern to a base station. Next, based on this, active learning may be performed.

By using signaling according to the above-described embodiments, for uncertainty sampling, information related to a receiver model of a terminal may be agreed between a base station and the terminal. An example of the agreed information is shown in Table 4 below.

TABLE 4

| Information | Example |
|---|---|
| Parameter prior distribution p(φ \| Dtrain) | Bernoulli probability |
| according to a transceiver model | distribution p = 0.5 |
| Acquisition function according to a | |
| transceiver model | |
| Supplementary calculation information of | Variation and monte-carlo |
| acquisition function | drop-out evaluation for |
| | final neural network layer |

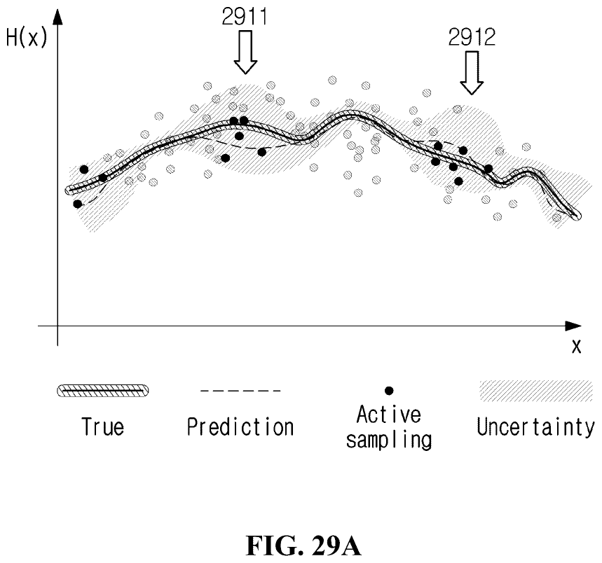

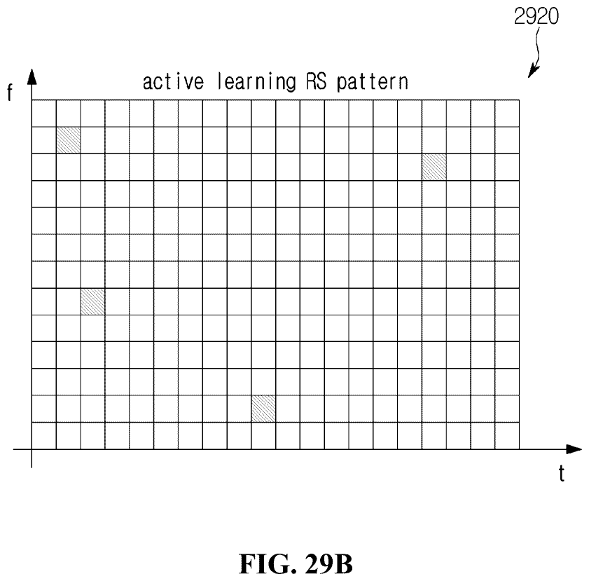

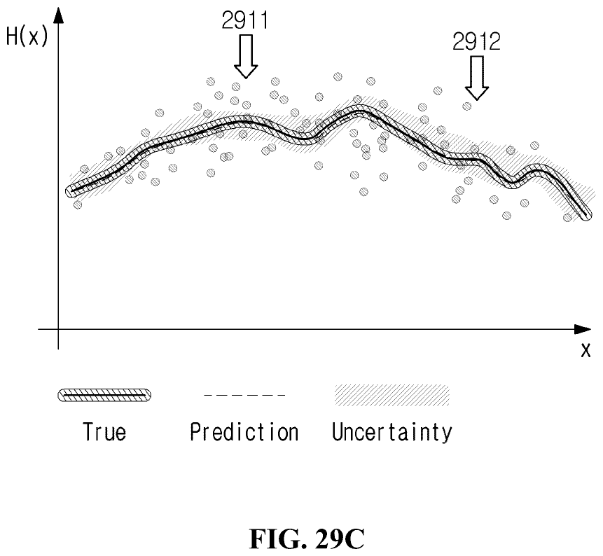

The easiest method of evaluating x*=arg max facq(x: φ), Dx [symbol] x for uncertainty sampling is to evaluate an acquisition function for every pattern corresponding to reference signals, which are transmitted according to prior agreement, and to select a largest acquisition function. FIG. 29A to FIG. 29C show an H(x) estimation problem for an independent variable x=(f,t) configured as a combination of a specific frequency, a symbol and an antenna port. The H(x) estimation problem corresponds to the regression problem in a machine learning algorithm and shows an error state between reality and prediction and uncertainty in shade.

FIG. 29A to FIG. 29C illustrate an example of uncertainty change according to uncertainty sampling-based active learning according to an embodiment of the present disclosure. Referring to FIG. 29A, a shaded region may be determined by a Bayesian algorithm according to a prior distribution of parameters of a machine learning model. Two regions 2911 and 2912 are parts with highest uncertainty, and active learning is performed for the parts with highest uncertainty. For example, a sample selected through active learning may have a pattern 2920 of FIG. 29B. A terminal may perform active learning by delivering the selected pattern 2920 to a base station. Herein, acquisition function information is not limited to a specific algorithm but may be determined by an agreement between a transmitter and a receiver. Active learning reference signals corresponding to the regions 2911 and 2912, which are evaluated to have high uncertainty, may be requested, and a result of learning may be as shown in FIG. 29C. Referring to FIG. 29C, the uncertainty of the regions 2911 and 2912 is reduced. That is, FIG. 29C shows that an uncertainty region of the H (x) estimation problem is reduced by active learning.

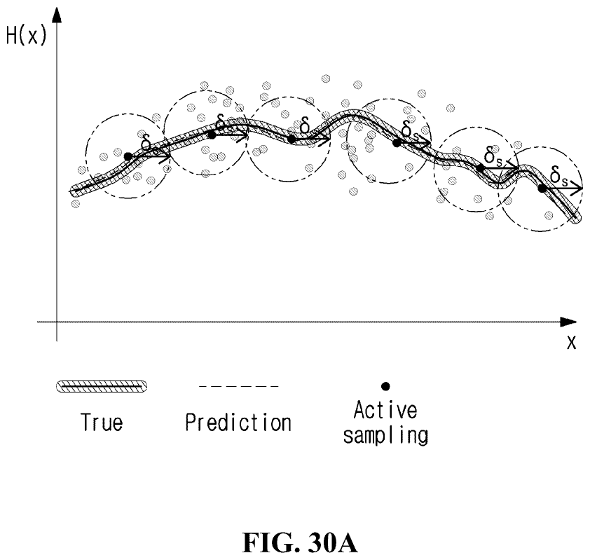

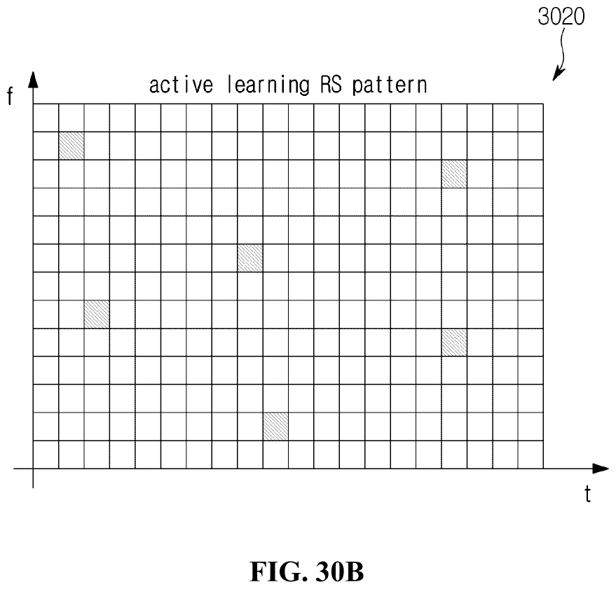

As a terminal is a moving object, when a new channel environment occurs in online learning, learning may be performed. To learn a representative channel in the new environment, the terminal may perform diversity sampling and request a pattern selected by diversity sampling to a base station. FIG. 30A and FIG. 30B show a situation of diversity sampling. FIG. 30A and FIG. 30B illustrate an example of pattern selection for diversity sampling-based active learning according to an embodiment of the present disclosure. As a radius δ covering channel estimation is larger, if a representative part is small, a representative channel with low density may be quickly learned. That is, by solving the set-cover problem, a desired active learning reference signal pattern may be requested to a base station. By using the proposed signaling, information on a Rx neural network of a terminal may be agreed for diversity sampling, as shown in Table 5 below, between a transmitter and a receiver.

TABLE 5

| Information | Example |
|---|---|
| Acquisition function according | Pattern function through a |
| to a transceiver model | k-center greedy algorithm |

Active learning includes repetition of the above-described process, and a terminal may adaptively perform active learning. In the proposed signaling, optimization information is not limited to a specific algorithm and may be determined by an agreement between a transmitter and a receiver.

As shown in the above-described various embodiments, active learning between a transmitter and a receiver may reduce labeling cost. That is, through uncertainty and diversity sampling between a transmitter and a receiver, a wireless resource for transmitting a reference signal may be minimized. To achieve such an effect, a transmitter and a receiver may mutually exchange a sampling method related to active learning, information on a model, and the like.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
transmitting capability information to a base station;
receiving configuration information related to reference signals from the base station;
receiving the reference signals based on the configuration information; and
transmitting feedback information corresponding to the reference signals,
wherein the feedback information includes information related to at least one preferred reference signal pattern selected by the UE and requests to transmit reference signals according to the preferred reference signal pattern.

2. The method of claim 1, wherein the capability information includes at least one of information indicating at least one supportable learning model, information indicating at least one supportable reference signal pattern, information indicating at least one supportable sampling method, or information indicating a feature of at least one supportable learning model.

3. The method of claim 1, wherein the configuration information includes at least one of information related to a pattern of the reference signals, information related to a model for active learning, a request for performing active learning, information related to an acquisition function for evaluating uncertainty or diversity, or a request for feedback indicating a preferred reference signal pattern.

4. The method of claim 1, further comprising:
performing prediction for the reference signals by using a receiver model;
determining an uncertainty metric or a diversity metric for a result of the prediction; and
determining the at least one preferred reference signal pattern based on the uncertainty metric or the diversity metric.

5. The method of claim 4, wherein the feedback information further includes a loss value for the result of the prediction.

6. The method of claim 1, further comprising:
receiving the reference signals according to the at least preferred reference signal pattern; and
performing training for a receiver model based on the reference signals according to the at least preferred reference signal pattern.

7. The method of claim 1, wherein uncertainty for the reference signals is determined by using a Bayesian model, and
wherein the uncertainty metric is determined based on at least one of Shannon entropy, an amount of mutual information of a receiver model, and a variation ratio of an output of the receiver model.

8. The method of claim 1, wherein diversity for the reference signals is determined based on a representative reference signal pattern that is selected by clustering.

9. The method of claim 1, wherein the reference signal pattern indicates at least one of a number of reference signals belonging to one set, a density of the reference signals, a spacing on a frequency axis of the reference signals, a spacing on a time axis of the reference signals, resource element (RE) positions allocated to the reference signals, one RE to which one reference is mappable, transmission power, a sequence, a covering code, a slot interval at which the reference signals are transmitted, and a property of a resource in which the reference signals are transmitted.

10. A method comprising:
receiving capability information from a user equipment (UE);
transmitting configuration information related to reference signals;
transmitting the reference signals based on the configuration information; and
receiving feedback information corresponding to the reference signals from the UE,
wherein the feedback information includes information related to at least one preferred reference signal pattern selected by the UE and requests to transmit reference signals according to the preferred reference signal pattern.

11. The method of claim 10, wherein the capability information includes at least one of information indicating at least one supportable learning model, information indicating at least one supportable reference signal pattern, information indicating at least one supportable sampling method, or information indicating a feature of at least one supportable learning model.

12. The method of claim 10, wherein the configuration information includes at least one of information related to a pattern of the reference signals, information related to a model for active learning, a request for performing active learning, information related to an acquisition function for evaluating uncertainty or diversity, or a request for feedback indicating a preferred reference signal pattern.

13. The method of claim 12, wherein the feedback information further includes a loss value for the result of the prediction.

14. The method of claim 10, further comprising transmitting reference signals according to the at least one preferred reference signal pattern.

15. A user equipment (UE) comprising:
a transceiver; and
a processor coupled with the transceiver,
wherein the processor is configured to:
transmit capability information to a base station,
receive configuration information related to reference signals from the base station,
receive the reference signals based on the configuration information, and
transmit feedback information corresponding to the reference signals,
wherein the feedback information includes information related to at least one preferred reference signal pattern selected by the UE and requests to transmit reference signals according to the preferred reference signal pattern.

16-18. (canceled)

19. The UE of claim 15, wherein the capability information includes at least one of information indicating at least one supportable learning model, information indicating at least one supportable reference signal pattern, information indicating at least one supportable sampling method, or information indicating a feature of at least one supportable learning model.

20. The UE of claim 15, wherein the configuration information includes at least one of information related to a pattern of the reference signals, information related to a model for active learning, a request for performing active learning, information related to an acquisition function for evaluating uncertainty or diversity, or a request for feedback indicating a preferred reference signal pattern.

21. The UE of claim 15, the processer is further comprising:
perform prediction for the reference signals by using a receiver model,
determine an uncertainty metric or a diversity metric for a result of the prediction, and
determine the at least one preferred reference signal pattern based on the uncertainty metric or the diversity metric.

22. The UE of claim 21, wherein the feedback information further includes a loss value for the result of the prediction.

23. The UE of claim 15, the processer is further comprising:
receive the reference signals according to the at least preferred reference signal pattern; and
perform training for a receiver model based on the reference signals according to the at least preferred reference signal pattern.
